(19) United States
(12) Patent Application Publication
(10) Pub. No.: US 2012/0200521 A1
(43) Pub. Date: Aug. 9, 2012

(54) LINEAR LIGHT SOURCE, BACKLIGHT DEVICE, AND DISPLAY APPARATUS

(75) Inventor: Makoto Yoshimura, Osaka-shi (JP)

(73) Assignee: SHARP KABUSHIKI KAISHA, Osaka-shi, Osaka (JP)

(21) Appl. No.: 13/499,917

(22) PCT Filed: Apr. 26, 2010
(86) PCT No.: PCT/JP10/57359

§ 371 Date: Apr. 3, 2012

(30) Foreign Application Priority Data
Oct. 23, 2009 (JP) 2009-244083

(51) Int. Cl. G06F 3/041; G09F 13/04; F21V 8/00; F21S 4/00

(52) U.S. Cl. 345/173; 362/219; 362/97.1; 362/613

(57) ABSTRACT

Provided is a linear light source capable of alleviating increases in display apparatus sizes. The linear light source (30) comprises white LEDs (31), infrared LEDs (32), and a substrate (33) whereupon the white LEDs and the infrared LEDs are arranged linearly. An anode terminal (33c) and a cathode terminal (33e) for the white LEDs are provided on an end section on one side of the substrate, and an anode terminal (33d) and a cathode terminal (33f) for the infrared LEDs are provided on an end section on the other side of the substrate.

### TECHNICAL FIELD

This invention relates to a linear light source, a backlight device, and a display apparatus, and more specifically to a linear light source including visible light emitting elements and invisible light emitting elements, and a backlight device and a display apparatus that include the linear light source.

### BACKGROUND ART

Conventionally, a display apparatus that includes a linear light source including visible light emitting elements and invisible light emitting elements is known.

FIG. 12 is a plan view illustrating the structure of a display apparatus including a linear light source according to a conventional example. FIGS. 13 to 15 are diagrams for explaining the structure of the linear light source in the display apparatus according to the conventional example illustrated in FIG. 12.

As illustrated in FIG. 12, a display apparatus 501 according to a conventional example includes a display panel 502, a drive IC (Integrated Circuit) 503 for driving the display panel 502, a frame 504 disposed on the rear surface side of the display panel 502, a light guide plate 505 (see FIG. 13) disposed on the rear surface side of the display panel 502, two linear light sources 510 (see FIG. 13) disposed on both sides in the longitudinal direction of the light guide plate 505 (direction A), and FPCs (Flexible Printed Circuits) 506 and 507 that are electrically connected to the linear light sources 510.

The display panel 502 is composed of a pair of transparent substrates having a liquid crystal layer (not illustrated) interposed therebetween, and is formed in a rectangular shape. Further, the display panel 502 functions as a touch panel. The drive IC 503 is mounted on one of the transparent substrates of the display panel 502. The frame 504 is formed in a frame shape so as to have an opening in a region thereof corresponding to a display region of the display panel 502.

As illustrated in FIG. 13, the two linear light sources 510 are disposed so as to extend in the short-side direction of the light guide plate 505 (direction B (direction perpendicular to the direction A)). As illustrated in FIGS. 14 and 15, each of the linear light sources 510 includes a plurality of white LEDs (visible light emitting elements) 511 that emit white light, a plurality of infrared LEDs (invisible light emitting elements) 512 that emit infrared light, and a substrate 513 having a main surface 513a on which the plurality of white LEDs 511 and the plurality of infrared LEDs 512 are mounted.

The white LEDs 511 are provided to display an image, and the infrared LEDs 512 are provided to detect a touch of a user's finger, a stylus, or the like on a surface of the display panel 502 (touch panel).

Four terminals 513c, 513d, 513e, and 513f are formed in one end portion on the main surface 513a of the substrate 513 in the direction B. The four terminals 513c to 513f are provided to supply electric power to the white LEDs 511 and the infrared LEDs 512.

As illustrated in FIG. 13, furthermore, the terminals 513c to 513f (see FIGS. 14 and 15) of one of the two linear light sources 510 are electrically connected to the FPC 506. The terminals 513c to 513f (see FIGS. 14 and 15) of the other linear light source 510 of the two linear light sources 510 are electrically connected to the FPC 507.

In addition, the four terminals 513c to 513f (see FIGS. 14 and 15) are disposed outward from end surfaces of the light guide plate 505 and the display panel 502 (see FIG. 12) on one side in the direction B. Therefore, as illustrated in FIG. 12, the frame 504 has projecting portions 504b and 504c that extend outward in the direction B so as to cover the terminals 513c to 513f.

In the display apparatus 501 according to the conventional example illustrated in FIG. 12, the four terminals 513c to 513f are provided on one side of each of the substrates 513 in the direction B. Thus, unlike a case where terminals 513c to 513f are provided separately on one side and the other side of each of the substrates 513 in the direction B, it is sufficient to connect one FPC 506 or 507 to only one side of each of the linear light sources 510 in the direction B. Therefore, an increase in the number of FPCs to be connected to the linear light sources 510 can be prevented.

A display apparatus in which visible light emitting elements and invisible light emitting elements are arranged linearly is disclosed in, for example, Patent Document 1.

### CITATION LIST

### Patent Literature

Patent Document 1: Japanese Unexamined Patent Application Publication No. 2009-229502 (pages 12 to 13, FIG. 5)

### SUMMARY OF INVENTION

### Technical Problem

In the display apparatus 501 according to the conventional example illustrated in FIG. 12, however, since the terminals 513c to 513f of the linear light sources 510 are disposed outward from end surfaces of the light guide plate 505 and the display panel 502 on one side in the direction B, the frame 504 needs to be provided with the projecting portions 504b and 504c that project outward in the direction B. Thus, there is a problem in that the overall size of the display apparatus 501 is increased.

This invention has been made in order to solve problems such as those described above, and it is an object of this invention to provide a linear light source, a backlight device, and a display apparatus that are capable of preventing an increase in the size of the display apparatus.

### Solution to Problem

In order to achieve the above object, a linear light source according to a first aspect of this invention includes visible light emitting elements, invisible light emitting elements, and a substrate including a main surface on which the visible light emitting elements and the invisible light emitting elements are arranged linearly. The substrate has thereon an anode terminal for the visible light emitting elements, a cathode terminal for the visible light emitting elements, an anode terminal for the invisible light emitting elements, and a cathode terminal for the invisible light emitting elements. The anode terminal for the visible light emitting elements, the cathode terminal for the visible light emitting elements, the anode terminal for the invisible light emitting elements, and the cathode terminal for the invisible light emitting elements are disposed separately in one end portion of the substrate and in another end portion of the substrate.

In the linear light source according to the first aspect, as described above, the anode terminal for the visible light emitting elements, the cathode terminal for the visible light emitting elements, the anode terminal for the invisible light emitting elements, and the cathode terminal for the invisible light emitting elements are disposed separately in one end portion of the substrate and in the other end portion of the substrate. Thus, compared to a case where, for example, terminals are disposed only in one end portion of the substrate, a projection amount by which the terminals on the substrate project outward from an end surface of a light guide plate or a display panel can be reduced. Since a display apparatus generally has a frame larger than a light guide plate or a display panel, the reduction in the projection amount of the terminals on the substrate in the manner described above allows the terminals on the substrate to be disposed within the frame. Thus, there is no need to provide a projecting portion for the frame or to increase the size of the frame, and therefore an increase in the overall size of the display apparatus can be prevented.

In addition, the anode terminal for the visible light emitting elements, the cathode terminal for the visible light emitting elements, the anode terminal for the invisible light emitting elements, and the cathode terminal for the invisible light emitting elements are disposed separately in the one end portion of the substrate and in the other end portion of the substrate, thus making it possible to make the projection amount of terminals disposed in the one end portion of the substrate equal to the projection amount of terminals disposed in the other end portion of the substrate. Thus, the contours on one side and the other side of the frame can be made symmetrical with respect to, for example, a display panel.

In the linear light source according to the first aspect, preferably, two of the anode terminal for the visible light emitting elements, the cathode terminal for the visible light emitting elements, the anode terminal for the invisible light emitting elements, and the cathode terminal for the invisible light emitting elements are disposed in the one end portion separately on the main surface and a back surface of the substrate, and the other two of the anode terminal for the visible light emitting elements, the cathode terminal for the visible light emitting elements, the anode terminal for the invisible light emitting elements, and the cathode terminal for the invisible light emitting elements are disposed in the other end portion separately on the main surface and the back surface of the substrate. With this configuration, compared to a case where, for example, a plurality of terminals are formed only on a main surface of a substrate, the projection amount of the terminals on the substrate can be reduced.

In the linear light source according to the first aspect, preferably, the anode terminal for the visible light emitting elements and the cathode terminal for the visible light emitting elements are disposed in the one end portion of the substrate, and the anode terminal for the invisible light emitting elements and the cathode terminal for the invisible light emitting elements are disposed in the other end portion of the substrate. With this configuration, it is sufficient to connect a wiring member for the visible light emitting elements to the one end portion of the substrate and to connect a wiring member for the invisible light emitting elements to the other end portion of the substrate.

In the linear light source according to the first aspect, preferably, the cathode terminal for the visible light emitting elements and the cathode terminal for the invisible light emitting elements are disposed in the one end portion of the substrate, and the anode terminal for the visible light emitting elements and the anode terminal for the invisible light emitting elements are disposed in the other end portion of the substrate. With this configuration, it is sufficient to connect a wiring member for the cathode terminals to the one end portion of the substrate and to connect a wiring member for the anode terminals to the other end portion of the substrate.

In the linear light source according to the first aspect, preferably, a terminal disposed in the one end portion of the substrate and a terminal disposed in the other end portion of the substrate among the anode terminal for the visible light emitting elements, the cathode terminal for the visible light emitting elements, the anode terminal for the invisible light emitting elements, and the cathode terminal for the invisible light emitting elements have different lengths in a direction in which the visible light emitting elements and the invisible light emitting elements are arranged. With this configuration, one side and the other side of the linear light source can be easily identified, and the efficiency with which work of assembling a backlight device is performed can therefore be improved.

In the linear light source according to the first aspect, preferably, the visible light emitting elements and the invisible light emitting elements are alternately arranged. With this configuration, uniform brightness can be achieved across the display panel.

In the linear light source according to the first aspect, the visible light emitting elements may include white light emitting elements.

In the linear light source according to the first aspect, the invisible light emitting elements may include infrared light emitting elements or ultraviolet light emitting elements.

A backlight device according to a second aspect of this invention includes the linear light source having the above configuration. With this configuration, a backlight device capable of preventing an increase in the size of a display apparatus can be obtained.

Preferably, the backlight device according to the second aspect further includes a light guide plate including a first side surface and a second side surface disposed opposite the first side surface, and the linear light source includes two linear light sources that irradiate the first side surface and the second side surface, respectively, of the light guide plate with light. With this configuration, light can be caused to enter the light guide plate through the first side surface and the second side surface thereof using two linear light sources, and brightness can therefore be easily improved.

Preferably, the backlight device that includes the two linear light sources described above further includes a wiring member that is electrically connected to the linear light sources. End portions of the two linear light sources on one side are connected to each other by the wiring member, and end portions of the two linear light sources on another side are also connected to each other by the wiring member. With this configuration, a wiring member can be shared between two linear light sources, and the wiring member can be easily led out in one side direction of the two linear light sources.

A display apparatus according to a third aspect of this invention includes the backlight device having the above configuration, and a touch panel that is irradiated with light from the backlight device. With this configuration, a display apparatus capable of preventing an increase in the size thereof can be obtained.

### Advantageous Effects of Invention

According to the present invention, therefore, a linear light source, a backlight device, and a display apparatus that are capable of preventing an increase in the size of the display apparatus can be easily obtained.

### BRIEF DESCRIPTION OF DRAWINGS

FIG. 1 is a perspective view illustrating the structure of a liquid crystal display apparatus including a linear light source according to a first embodiment of the present invention.

FIG. 2 is an exploded perspective view illustrating the structure of the liquid crystal display apparatus including the linear light source according to the first embodiment of the present invention.

FIG. 3 is a perspective view illustrating the structure of the linear light source according to the first embodiment of the present invention illustrated in FIG. 2.

FIG. 4 is a perspective view illustrating the structure of the linear light source according to the first embodiment of the present invention illustrated in FIG. 2, as viewed from the back surface side.

FIG. 5 is a plan view illustrating the structure of the linear light source according to the first embodiment of the present invention illustrated in FIG. 2.

FIG. 6 is a side view illustrating the structure of the linear light source according to the first embodiment of the present invention illustrated in FIG. 2.

FIG. 7 is a bottom view illustrating the structure of the linear light source according to the first embodiment of the present invention illustrated in FIG. 2.

FIG. 8 is a perspective view illustrating the structure of the linear light source and FPCs according to the first embodiment of the present invention illustrated in FIG. 2.

FIG. 9 is an exploded perspective view illustrating the structure of the linear light source and the FPCs according to the first embodiment of the present invention illustrated in FIG. 8.

FIG. 10 is a perspective view illustrating the structure of a linear light source according to a second embodiment of the present invention.

FIG. 11 is a perspective view illustrating the structure of the linear light source according to the second embodiment of the present invention illustrated in FIG. 10, as viewed from the back surface side.

FIG. 12 is a plan view illustrating the structure of a display apparatus including a linear light source according to a conventional example.

FIG. 13 is a plan view for explaining the structure of the linear light source in the display apparatus according to the conventional example illustrated in FIG. 12.

FIG. 14 is a plan view illustrating the structure of the linear light source in the display apparatus according to the conventional example illustrated in FIG. 12.

FIG. 15 is a side view illustrating the structure of the linear light source in the display apparatus according to the conventional example illustrated in FIG. 12.

### DESCRIPTION OF EMBODIMENTS

Embodiments of the present invention will be described hereinafter with reference to the drawings.

### First Embodiment

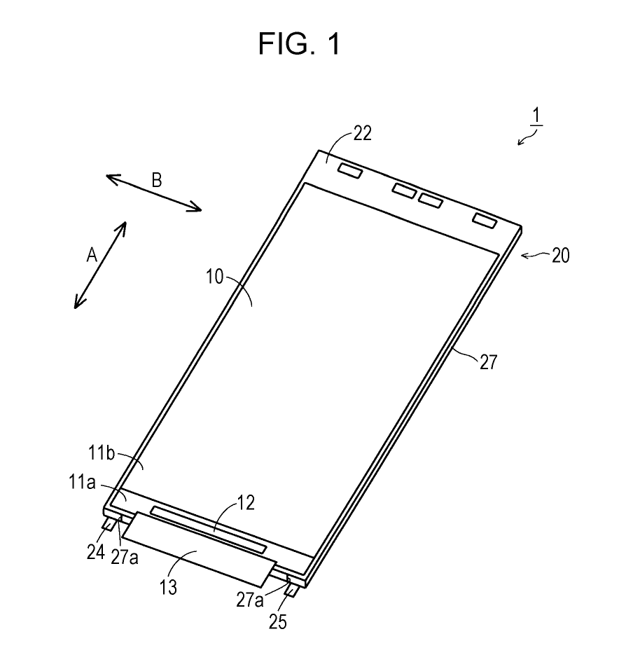

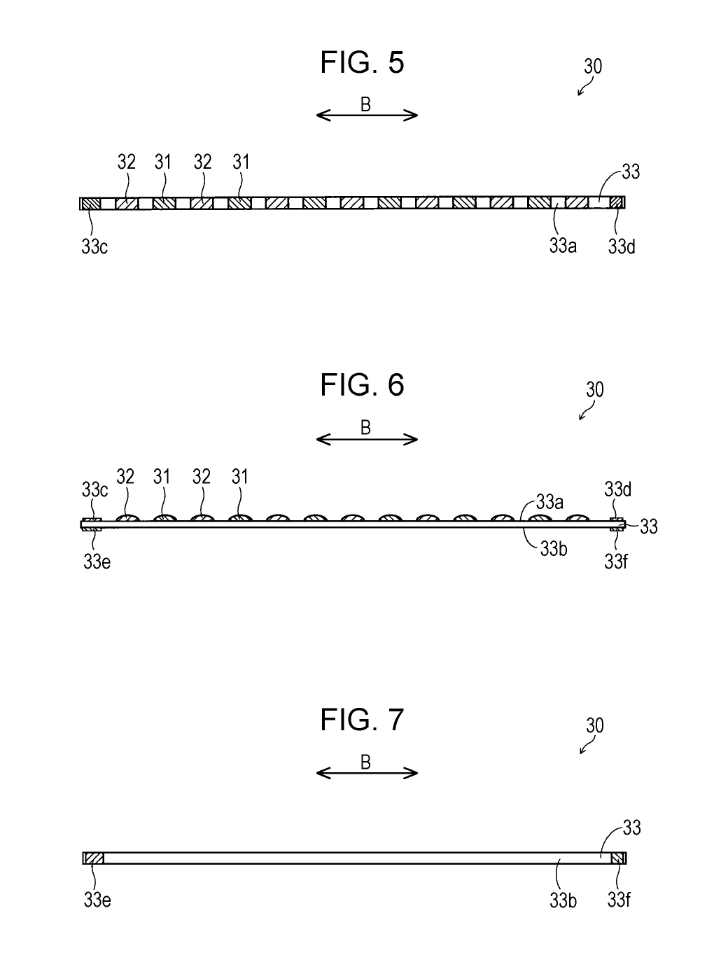

A liquid crystal display apparatus 1 including a linear light source 30 according to a first embodiment of the present invention will be described with reference to FIGS. 1 to 9. For ease of understanding, hatching may be used in plan views, side views, and bottom views.

The liquid crystal display apparatus 1 may be used in, for example, a mobile device such as a mobile telephone. As illustrated in FIG. 1, the liquid crystal display apparatus 1 is composed of a liquid crystal display panel 10, and a backlight device 20 disposed on the rear surface side of the liquid crystal display panel 10. The liquid crystal display apparatus 1 is an example of a “display apparatus” according to the present invention, and the liquid crystal display panel 10 is an example of a “touch panel” according to the present invention.

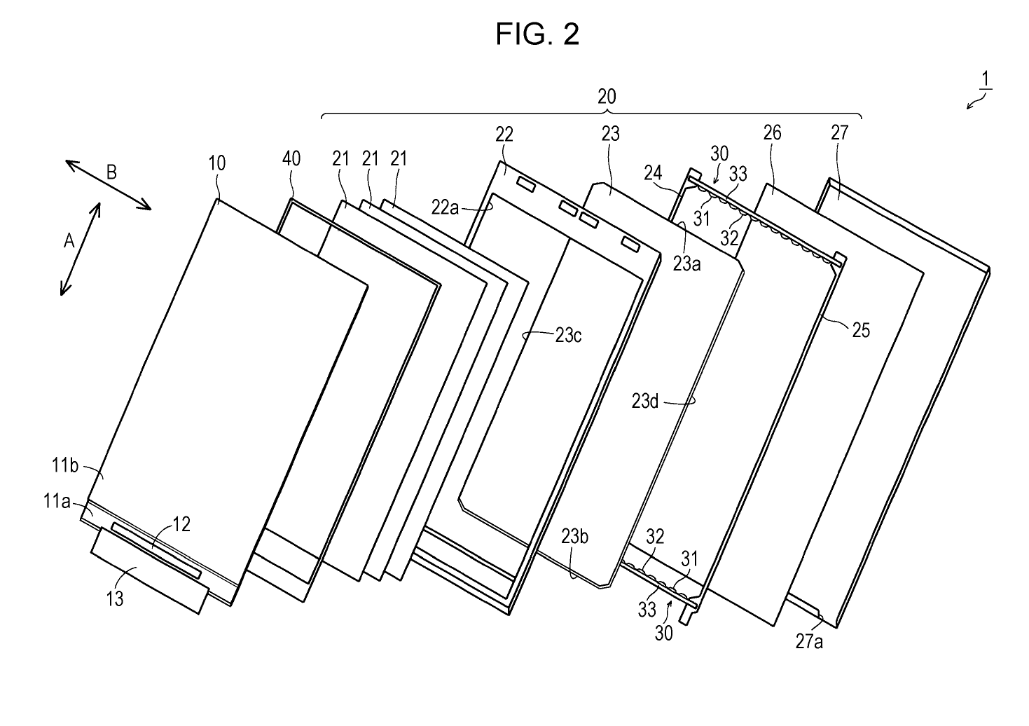

As illustrated in FIG. 2, the liquid crystal display panel 10 is formed in a rectangular shape, and includes an AM substrate (active matrix substrate) 11a and a counter substrate 11b disposed so as to face the AM substrate 11a. A liquid crystal (not illustrated) is sealed between the AM substrate 11a and the counter substrate 11b. The liquid crystal display panel 10 functions as a display panel as a result of being illuminated by the backlight device 20.

The AM substrate 11a has a larger area than the counter substrate 11b. To a predetermined region of the AM substrate 11a, a drive IC 12 for driving the liquid crystal display panel 10 and an FPC 13 for inputting a control signal to the drive IC 12 are electrically connected.

The liquid crystal display panel 10 further has light receiving elements, which are photodiodes or the like (not illustrated) arranged in a matrix for detecting a touch of a user's finger, a stylus, or the like, and the liquid crystal display panel 10 also functions as a touch panel. A touch panel having light receiving elements (not illustrated) arranged in a matrix for detecting a touch of a user's finger, a stylus, or the like may be bonded to the liquid crystal display panel 10.

The backlight device 20 is formed in a rectangular shape. Further, the backlight device 20 is an edge-light backlight device, and includes a plurality of optical sheets 21 disposed on the rear surface side of the liquid crystal display panel 10, a resin frame 22 that surrounds the optical sheets 21, a light guide plate 23 disposed inside the frame 22, two linear light sources 30 that irradiate the light guide plate 23 with light, two FPCs 24 and 25 that connect the two linear light sources 30 to each other, a reflection sheet 26 disposed on the rear surface side of the light guide plate 23, and a back chassis 27 that houses the above components. The peripheral portion of the liquid crystal display panel 10 is fixed to the frame 22 (backlight device 20) using an adhesive sheet 40. The FPCs 24 and 25 are examples of a “wiring member” according to the present invention.

The plurality of optical sheets 21 include a prism sheet, a lens sheet, and/or the like, and have a function of condensing light from the light guide plate 23 within a predetermined viewing angle.

The frame 22 has an opening 22a formed in a region thereof corresponding to a display region of the liquid crystal display panel 10.

The light guide plate 23 is formed of resin or the like having light transmission properties. The light guide plate 23 includes side surfaces 23a and 23b formed on both sides in the longitudinal direction thereof (direction A), and side surfaces 23c and 23d formed on both sides in the short-side direction thereof (direction B (direction perpendicular to the direction A)). Furthermore, the light guide plate 23 is formed so that light coming from the linear light sources 30 is emitted toward the liquid crystal display panel 10 side through the light guide plate 23. The side surface 23a is an example of a “first side surface” according to the present invention, and the side surface 23b is an example of a “second side surface” according to the present invention.

The two linear light sources 30 are disposed so as to extend in the direction B. The two linear light sources 30 are also disposed so as to face the side surfaces 23a and 23b of the light guide plate 23. The light emitted from the linear light source 30 enters the light guide plate 23, and is emitted toward the liquid crystal display panel 10.

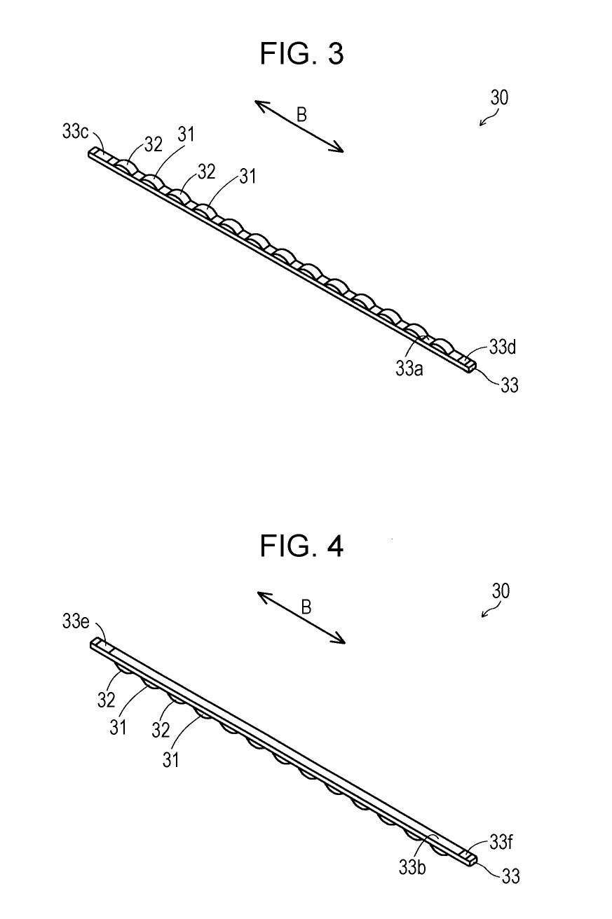

Here, in the first embodiment, as illustrated in FIGS. 3 to 7, each of the linear light sources 30 is composed of a plurality of white LEDs 31 that emit white light, a plurality of infrared LEDs 32 that emit infrared light, and an elongated substrate 33 having a main surface 33a (see FIG. 3) on which the plurality of white LEDs 31 and the plurality of infrared LEDs 32 are mounted. The white LEDs 31 are examples of “visible light emitting elements” and “white light emitting elements” according to the present invention. The infrared LEDs 32 are examples of “invisible light emitting elements” and “infrared light emitting elements” according to the present invention.

In the first embodiment, furthermore, the white LEDs 31 and the infrared LEDs 32 are alternately arranged on the main surface 33a of the substrate 33. In addition, the white LEDs 31 and the infrared LEDs 32 are arranged at constant pitches in the direction B. Additionally, the white LEDs 31 and the infrared LEDs 32 are arranged symmetrically with respect to the center of the substrate 33 in the direction B.

The white LEDs 31 are provided to display an image on the liquid crystal display panel 10 (see FIG. 2). The white LEDs 31 are composed of, for example, blue LEDs and fluorescent materials that convert part of blue light emitted from the blue LEDs into yellow light. The white LEDs 31 may be composed of red LEDs, green LEDs, and blue LEDs, or may have any other configuration.

The infrared LEDs 32 are provided to detect a touch of a user's finger, a stylus, or the like on the liquid crystal display panel 10 (see FIG. 2). Specifically, when infrared light is emitted from the infrared LEDs 32, the infrared light is emitted toward the liquid crystal display panel 10 (touch panel) through the light guide plate 23 (see FIG. 2). Then, the infrared light is emitted in front of the liquid crystal display panel 10 (touch panel). At this time, if a user's finger, a stylus, or the like touches (or approaches) the liquid crystal display panel 10 (touch panel), the infrared light is reflected toward the liquid crystal display panel 10 (touch panel) side, and the reflected infrared light is detected by using the light receiving elements described above (not illustrated). It is therefore possible to detect a touch (or approach) of the user's finger, the stylus, or the like on the liquid crystal display panel 10 (touch panel).

The use of light emitting elements that emit invisible light (the infrared LEDs 32) to detect a touch of a user's finger, a stylus, or the like on the liquid crystal display panel 10 (touch panel) helps avoid a situation where the image displayed on the liquid crystal display panel 10 does not have a desired hue.

In the first embodiment, a white LED anode terminal 33c that functions as an anode terminal of the white LEDs 31 is formed in one end portion on the main surface 33a of the substrate 33 in the direction B, and an infrared LED anode terminal 33d that functions as an anode terminal of the infrared LEDs 32 is formed in the other end portion on the main surface 33a of the substrate 33 in the direction B. Further, a white LED cathode terminal 33e that functions as a cathode terminal of the white LEDs 31 is formed in the one end portion on the back surface 33b of the substrate 33 in the direction B, and an infrared LED cathode terminal 33f that functions as a cathode terminal of the infrared LEDs 32 is formed in the other end portion on the back surface 33b of the substrate 33 in the direction B.

The white LED anode terminal 33c is an example of an “anode terminal” according to the present invention, and the infrared LED anode terminal 33d is an example of an “anode terminal” according to the present invention. The white LED cathode terminal 33e is an example of a “cathode terminal” according to the present invention, and the infrared LED cathode terminal 33f is an example of a “cathode terminal” according to the present invention.

The white LED anode terminal 33c and the white LED cathode terminal 33e are provided to supply electric power to the white LEDs 31. The infrared LED anode terminal 33d and the infrared LED cathode terminal 33f are provided to supply electric power to the infrared LEDs 32.

In the first embodiment, furthermore, the white LED anode terminal 33c is formed so as to be longer in the direction B (direction in which the white LEDs 31 and the infrared LEDs 32 are arranged) than the infrared LED anode terminal 33d. That is, the white LED anode terminal 33c and the infrared LED anode terminal 33d are formed so as to have different lengths in the direction B.

Similarly, the white LED cathode terminal 33e is formed so as to be longer in the direction B (direction in which the white LEDs 31 and the infrared LEDs 32 are arranged) than the infrared LED cathode terminal 33f. That is, the white LED cathode terminal 33e and the infrared LED cathode terminal 33f are formed so as to have different lengths in the direction B.

The white LED anode terminal 33c and the white LED cathode terminal 33e may be formed so as to have the same length in the direction B, or may be formed so as to have different lengths in the direction B. The infrared LED anode terminal 33d and the infrared LED cathode terminal 33f may be formed so as to have the same length in the direction B, or may be formed so as to have different lengths in the direction B.

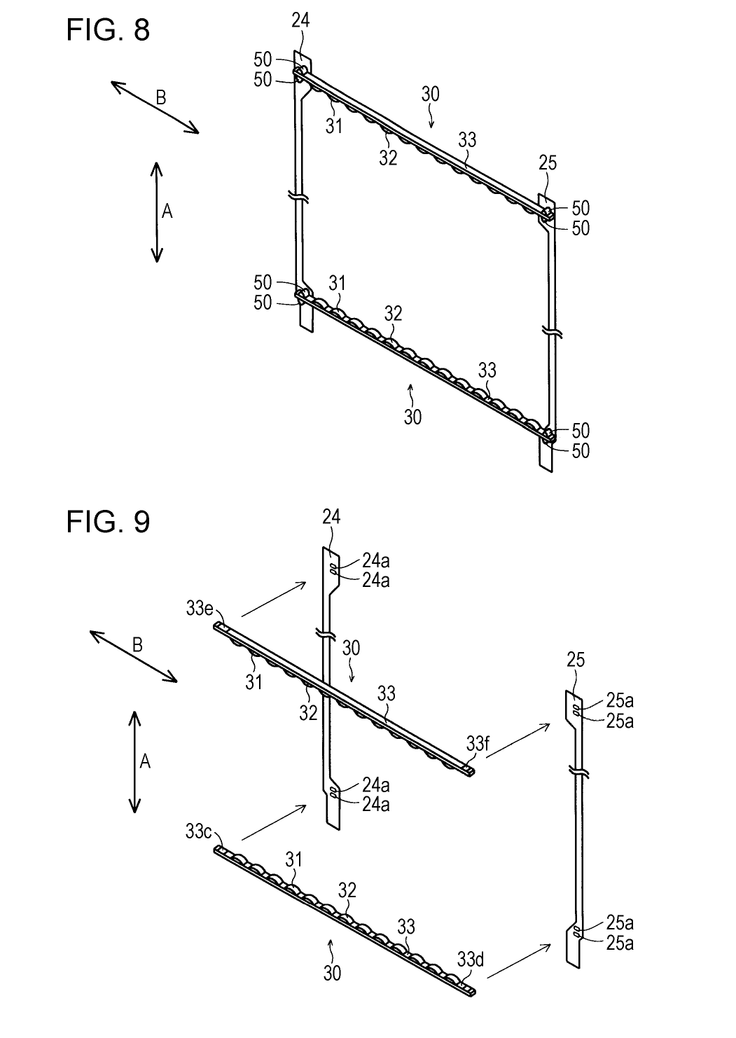

As illustrated in FIGS. 8 and 9, the FPCs 24 and 25 are formed in an elongated shape extending in the direction A. Furthermore, the FPCs 24 and 25 are disposed on one side and the other side of the light guide plate 23 (see FIG. 2) in the direction B, respectively.

As illustrated in FIG. 9, a plurality of terminal units 24a to be connected to the white LED anode terminals 33c and the white LED cathode terminals 33e of the linear light sources 30 are formed on both sides (upper and lower sides) of the FPC 24 in the direction A. That is, in the first embodiment, the FPC 24 connects terminals (the white LED anode terminals 33c and the white LED cathode terminals 33e) of the two linear light sources 30 on one side in the direction B to each other, and also functions as a wiring member for the white LEDs 31. Therefore, the FPC 24 can be shared between the two linear light sources 30, thus making it possible to prevent an increase in the number of wiring members (FPC 24) for the white LEDs 31. The terminal units 24a are led out to the lower side of the frame 22 (see FIG. 1) (one side in the direction A) via a wiring line (not illustrated).

Similarly, a plurality of terminal units 25a to be connected to the infrared LED anode terminals 33d and the infrared LED cathode terminals 33f of the linear light sources 30 are formed on both sides (upper and lower sides) of the FPC 25 in the direction A. That is, in the first embodiment, the FPC 25 connects terminals (the infrared LED anode terminals 33d and the infrared LED cathode terminals 33f) of the two linear light sources 30 on the other side in the direction B to each other, and also functions as a wiring member for the infrared LEDs 32. Therefore, the FPC 25 can be shared between the two linear light sources 30, thus making it possible to prevent an increase in the number of wiring members (FPC 25) for the infrared LEDs 32. The terminal units 25a are led out to the lower side of the frame 22 (see FIG. 1) (one side in the direction A) via a wiring line (not illustrated).

As illustrated in FIGS. 8 and 9, the white LED anode terminals 33c and the white LED cathode terminals 33e of the linear light sources 30 are electrically connected to the terminal units 24a of the FPC 24 using solder 50. The infrared LED anode terminals 33d and the infrared LED cathode terminals 33f of the linear light sources 30 are electrically connected to the terminal units 25a of the FPC 25 using solder 50.

As illustrated in FIG. 2, the reflection sheet 26 has a function of reflecting light emitted from the rear surface of the light guide plate 23 forward (toward the light guide plate 23 side).

The back chassis 27 is formed of resin or metal. The back chassis 27 has a cutout portion 27a through which the FPCs 24 and 25 are led out from the frame 22.

In the first embodiment, as described above, the white LED anode terminals 33c and the white LED cathode terminals 33e are provided in end portions of the substrates 33 on one side in the direction B, and the infrared LED anode terminals 33d and the infrared LED cathode terminals 33f are provided in end portions of the substrates 33 on the other side in the direction B. Therefore, compared to the case where four terminals (the white LED anode terminal 33c, the white LED cathode terminal 33e, the infrared LED anode terminal 33d, and the infrared LED cathode terminal 33f) are disposed only in, for example, one end portion of each of the substrates 33, a projection amount by which the four terminals on each of the substrates 33 project outward from a side surface of the light guide plate 23 or the liquid crystal display panel 10 (touch panel) in the direction B can be reduced. This allows the four terminals on each of the substrates 33 to be disposed within the frame 22. Thus, there is no need to provide projecting portions for the frame 22 or to increase the size of the frame 22. This results in prevention of an increase in the overall size of the liquid crystal display apparatus 1.

In addition, the white LED anode terminals 33c and the white LED cathode terminals 33e are provided in end portions of the substrates 33 on one side in the direction B, and the infrared LED anode terminals 33d and the infrared LED cathode terminals 33f are provided in end portions of the substrates 33 on the other side in the direction B. Therefore, the projection amount of the terminals (the white LED anode terminals 33c and the white LED cathode terminals 33e) on the substrates 33 on one side in the direction B can be made equal to that of the terminals (the infrared LED anode terminals 33d and the infrared LED cathode terminals 33f) on the substrates 33 on the other side in the direction B. Thus, the contours on one side and the other side of the frame 22 can be made symmetrical with respect to, for example, the liquid crystal display panel 10.

In the first embodiment, furthermore, as described above, the white LED anode terminals 33c and the white LED cathode terminals 33e are formed separately on the main surfaces 33a and the back surfaces 33b of the substrates 33, and the infrared LED anode terminals 33d and the infrared LED cathode terminals 33f are formed separately on the main surfaces 33a and the back surfaces 33b of the substrates 33. Therefore, compared to a case where four terminals (the white LED anode terminal 33c, the white LED cathode terminal 33e, the infrared LED anode terminal 33d, and the infrared LED cathode terminal 33f) are formed only on, for example, the main surface 33a of each of the substrates 33, the projection amount of the four terminals in the direction B can be reduced.

In the first embodiment, furthermore, as described above, the white LED anode terminals 33c and the infrared LED anode terminals 33d are formed so as to have different lengths in the direction B, and the white LED cathode terminals 33e and the infrared LED cathode terminals 33f are formed so as to have different lengths in the direction B. This can make it easy to identify one side and the other side of each of the linear light sources 30, and can therefore improve the efficiency with which work of assembling the backlight device 20 is performed.

In the first embodiment, furthermore, as described above, the white LEDs 31 and the infrared LEDs 32 are alternately arranged. Therefore, uniform brightness can be achieved across the liquid crystal display panel 10, and a reduction in detection accuracy of the touch panel (liquid crystal display panel 10) can also be prevented.

In the first embodiment, furthermore, as described above, the two linear light sources 30 are used to cause light to enter the light guide plate 23 through the side surfaces 23a and 23b thereof. Thus, the brightness across the liquid crystal display panel 10 can be easily improved.

In the first embodiment, furthermore, as described above, terminals (the white LED anode terminals 33c and the white LED cathode terminals 33e) on the two linear light sources 30 on one side are electrically connected to the FPC 24, and terminals (the infrared LED anode terminals 33d and the infrared LED cathode terminals 33f) on the two linear light sources 30 on the other side are electrically connected to the FPC 25. Thus, the FPCs 24 and 25 can be shared between the two linear light sources 30, and the FPCs 24 and 25 can also be easily led out to one side (lower side) in the direction A.

In addition, the FPCs 24 and 25 are disposed on one side and the other side in the direction B, respectively. Thus, compared to a case where an FPC formed by integrating the FPC 24 and the FPC 25 is disposed only on, for example, one side in the direction B, a projection amount in the direction B by which the FPC projects outward from one end surface of the light guide plate 23 or the liquid crystal display panel 10 (touch panel) in the direction B can be reduced.

### Second Embodiment

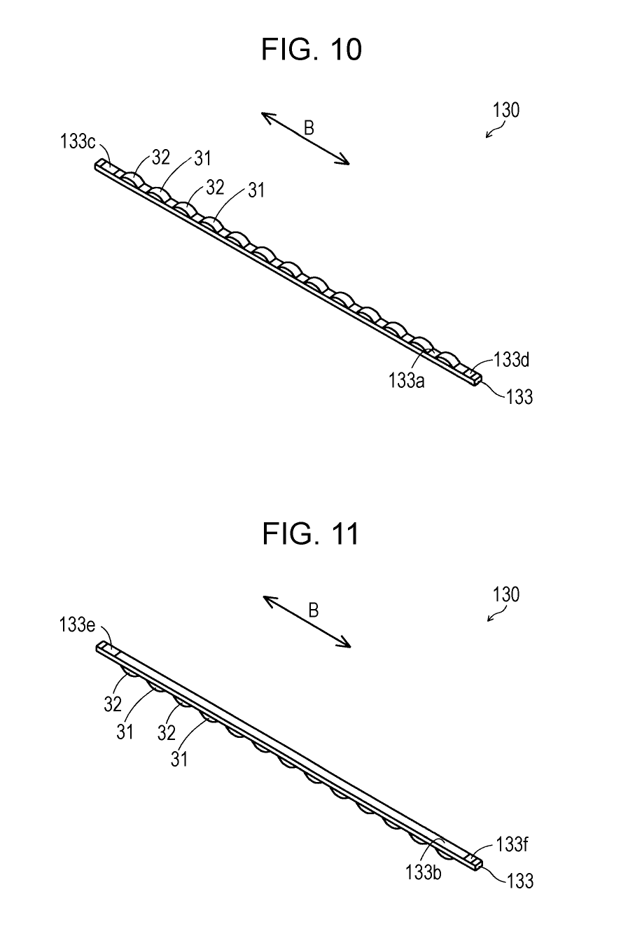

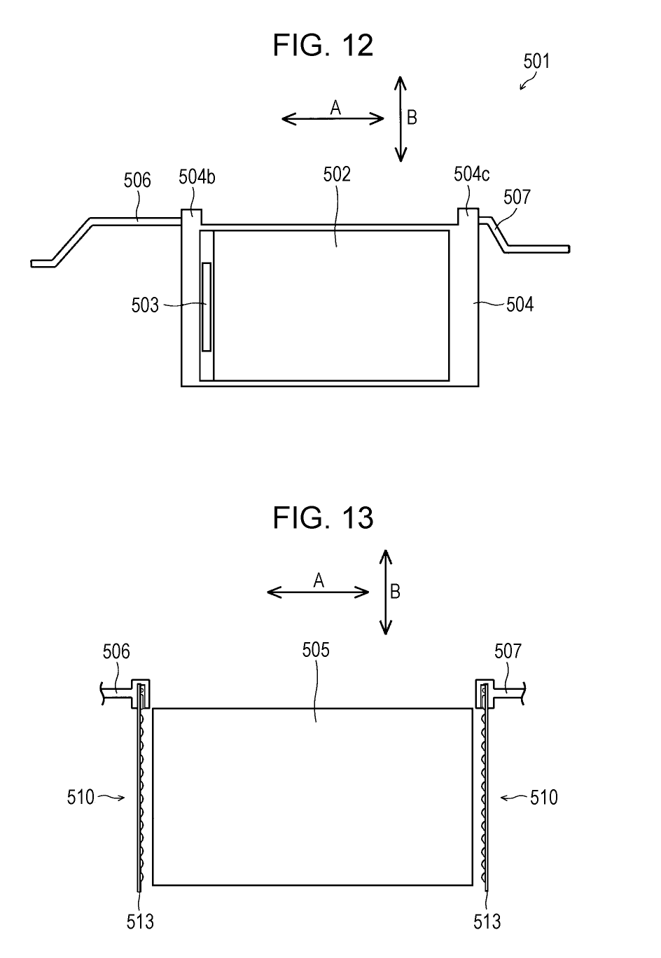

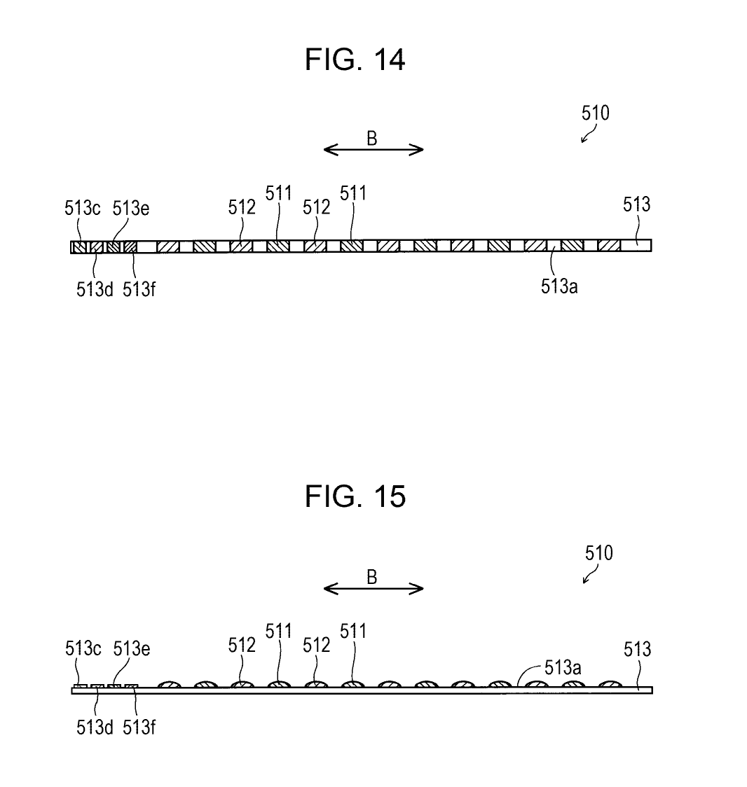

In a second embodiment, a case where, unlike in the first embodiment described above, cathode terminals are formed on one side of a substrate 133 of a linear light source 130 in the direction B and anode terminals are formed on the other side of the substrate 133 in the direction B will be described with reference to FIGS. 10 and 11.

In the linear light source 130 according to the second embodiment of the present invention, as illustrated in FIGS. 10 and 11, an infrared LED cathode terminal 133c that functions as a cathode terminal of the infrared LEDs 32 is formed in one end portion on a main surface 133a of the substrate 133 in the direction B, and an infrared LED anode terminal 133d that functions as an anode terminal of the infrared LEDs 32 is formed in the other end portion on the main surface 133a of the substrate 133 in the direction B. Further, a white LED cathode terminal 133e that functions as a cathode terminal of the white LEDs 31 is formed in the one end portion on a back surface 133b of the substrate 133 in the direction B, and a white LED anode terminal 133f that functions as an anode terminal of the white LEDs 32 is formed in the other end portion on the back surface 133b of the substrate 133 in the direction B.

The infrared LED cathode terminal 133c is an example of a “cathode terminal” according to the present invention, and the infrared LED anode terminal 133d is an example of an “anode terminal” according to the present invention. Further, the white LED cathode terminal 133e is an example of a “cathode terminal” according to the present invention, and the white LED anode terminal 133f is an example of an “anode terminal” according to the present invention.

In the second embodiment, the FPC 24 functions as a cathode terminal wiring member, and the FPC 25 functions as an anode terminal wiring member. In the second embodiment, all the plurality of terminal units 24a formed on the FPC 24 may be implemented as a common unit.

Other structures and other advantageous effects of the second embodiment are similar to those of the first embodiment described above.

It should be considered that the embodiments disclosed herein are illustrative and not restrictive in any respects. The scope of the present invention is indicated by the claims rather than the foregoing description of the embodiments, and all changes that come within the meaning and range of equivalence of the claims are intended to be embraced.

For example, in the foregoing embodiments, an example is given in which a display apparatus is applied to a liquid crystal display apparatus. However, the present invention is not limited thereto, and may be applied to a display apparatus other than a liquid crystal display apparatus.

In the foregoing embodiments, furthermore, an example is given in which an LED is used as a light emitting element. However, the present invention is not limited thereto, and a light emitting element other than an LED, such as a semiconductor laser element, may be used.

In the foregoing embodiments, furthermore, an example is given in which a white LED is used as a visible light emitting element. However, the present invention is not limited thereto, and a light emitting element that emits visible light other than white light may be used.

In the foregoing embodiments, furthermore, an example is given in which an infrared LED is used as an invisible light emitting element. However, the present invention is not limited thereto, and a light emitting element that emits invisible light (for example, ultraviolet light) other than infrared light may be used.

In the foregoing embodiments, furthermore, an example is given in which a linear light source is disposed on either side of a light guide plate in the direction A. However, the present invention is not limited thereto, and a linear light source may be disposed only on one side of a light guide plate.

In the foregoing embodiments, furthermore, an example is given in which white LEDs and infrared LEDs are arranged alternately one by one. However, the present invention is not limited thereto, and white LEDs and infrared LEDs may be arranged, for example, alternately two by two, or may be arranged in any other order.

In the foregoing embodiments, furthermore, an example is given in which two linear light sources are connected to each other by two FPCs. However, the present invention is not limited thereto, and two linear light sources may be connected to each other by a single FPC. That is, an FPC that connects one side of one of two linear light sources to one side of the other linear light source, and an FPC that connects the other side of one of the two linear light sources to the other side of the other linear light source may be formed by a single FPC. Alternatively, two linear light sources may not necessarily be connected to each other.

In the first embodiment described above, an example is given in which anode terminals (white LED anode terminal and infrared LED anode terminal) are formed on a main surface of a substrate and in which cathode terminals (white LED cathode terminal and infrared LED cathode terminal) are formed on a back surface of the substrate. However, the present invention is not limited thereto. The cathode terminals may be formed on the main surface of the substrate, and the anode terminals may be formed on the back surface of the substrate.

In the foregoing embodiments, furthermore, an example is given in which a terminal on one side of a substrate and a terminal on the other side of the substrate are formed so as to have different lengths. However, the present invention is not limited thereto, and a terminal on one side of a substrate and a terminal on the other side of the substrate may be formed so as to have different shapes. Alternatively, a terminal on one side of a substrate and a terminal on the other side of the substrate may be formed so as to have the same shape and the same length.

In the foregoing embodiments, furthermore, an example is given in which the present invention is applied to an edge-light backlight device. However, the present invention is not limited thereto. The present invention may be applied to a direct backlight device.

### REFERENCE SIGNS LIST

1 liquid crystal display apparatus (display apparatus)
10 liquid crystal display panel (touch panel)
20 backlight device
23 light guide plate
23a side surface (first side surface)
23b side surface (second side surface)
24, 25 FPC (wiring member)
30, 130 linear light source
31 white LED (visible light emitting element, white light emitting element)
32 infrared LED (invisible light emitting element, infrared light emitting element)
33, 133 substrate
33a, 133a main surface
33b, 133b back surface
33c, 133f white LED anode terminal (anode terminal)
33d, 133d infrared LED anode terminal (anode terminal)
33e, 133e white LED cathode terminal (cathode terminal)
33f, 133c infrared LED cathode terminal (cathode terminal)

1. A linear light source comprising:
visible light emitting elements;
invisible light emitting elements; and
a substrate including a main surface on which the visible light emitting elements and the invisible light emitting elements are arranged linearly,
wherein the substrate has thereon an anode terminal for the visible light emitting elements, a cathode terminal for the visible light emitting elements, an anode terminal for the invisible light emitting elements, and a cathode terminal for the invisible light emitting elements, and
wherein the anode terminal for the visible light emitting elements, the cathode terminal for the visible light emitting elements, the anode terminal for the invisible light emitting elements, and the cathode terminal for the invisible light emitting elements are disposed separately in one end portion of the substrate and in another end portion of the substrate.

2. The linear light source according to claim 1, wherein two of the anode terminal for the visible light emitting elements, the cathode terminal for the visible light emitting elements, the anode terminal for the invisible light emitting elements, and the cathode terminal for the invisible light emitting elements are disposed in the one end portion separately on the main surface and a back surface of the substrate, and
wherein the other two of the anode terminal for the visible light emitting elements, the cathode terminal for the visible light emitting elements, the anode terminal for the invisible light emitting elements, and the cathode terminal for the invisible light emitting elements are disposed in the other end portion separately on the main surface and the back surface of the substrate.

3. The linear light source according to claim 1, wherein the anode terminal for the visible light emitting elements and the cathode terminal for the visible light emitting elements are disposed in the one end portion of the substrate, and
wherein the anode terminal for the invisible light emitting elements and the cathode terminal for the invisible light emitting elements are disposed in the other end portion of the substrate.

4. The linear light source according to claim 1, wherein the cathode terminal for the visible light emitting elements and the cathode terminal for the invisible light emitting elements are disposed in the one end portion of the substrate, and
wherein the anode terminal for the visible light emitting elements and the anode terminal for the invisible light emitting elements are disposed in the other end portion of the substrate.

5. The linear light source according to claim 1, wherein a terminal disposed in the one end portion of the substrate and a terminal disposed in the other end portion of the substrate among the anode terminal for the visible light emitting elements, the cathode terminal for the visible light emitting elements, the anode terminal for the invisible light emitting elements, and the cathode terminal for the invisible light emitting elements have different lengths in a direction in which the visible light emitting elements and the invisible light emitting elements are arranged.

6. The linear light source according to claim 1, wherein the visible light emitting elements and the invisible light emitting elements are alternately arranged.

7. The linear light source according to claim 1, wherein the visible light emitting elements include white light emitting elements.

8. The linear light source according to claim 1, wherein the invisible light emitting elements include infrared light emitting elements or ultraviolet light emitting elements.

9. A backlight device comprising the linear light source according to claim 1.

10. The backlight device according to claim 9, further comprising a light guide plate including a first side surface and a second side surface disposed opposite the first side surface,
wherein the linear light source includes two linear light sources that irradiate the first side surface and the second side surface, respectively, of the light guide plate with light.

11. The backlight device according to claim 10, further comprising a wiring member that is electrically connected to the linear light source,
wherein end portions of the two linear light sources on one side are connected to each other by the wiring member, and
wherein end portions of the two linear light sources on another side are also connected to each other by the wiring member.

12. A display apparatus comprising:
the backlight device according to claim 9; and
a touch panel that is irradiated with light from the backlight device.
